(19) United States
(12) Patent Application Publication
(10) Pub. No.: US 2024/0426699 A1
(43) Pub. Date: Dec. 26, 2024

(54) VIEW BLIND CHECK SYSTEM, VIEW BLIND CHECK METHOD, AND VIEW BLIND METHOD

(71) Applicant: NITTO DENKO CORPORATION, Osaka (JP)

(72) Inventors: Saori Yamamoto, Osaka (JP); Minoru Miyatake, Osaka (JP); Yuji Toyota, Osaka (JP)

(73) Assignee: NITTO DENKO CORPORATION, Osaka (JP)

(21) Appl. No.: 18/749,839

(22) Filed: Jun. 21, 2024

(30) Foreign Application Priority Data
Jun. 23, 2023 (JP) 2023-103609

(51) Int. Cl. G01M 11/02; G02B 5/30

(52) U.S. Cl. CPC G01M 11/0207; G02B 5/3033

(57) ABSTRACT

There is provided a view blind check system that allows whether or not a display arranged inside a space viewable through a polarizer is blinded to be checked. The view blind check system includes a polarizing film including the polarizer and a mirror member. The mirror member is arranged on a side of the polarizing film opposite to a side on which the display is arranged so that the mirror member reflects an image of the display through the polarizing film.

### BACKGROUND OF THE INVENTION

This application claims priority under 35 U.S.C. Section 119 to Japanese Patent Application No. 2023-103609 filed on Jun. 23, 2023 which is herein incorporated by reference.

### 1. FIELD OF THE INVENTION

The present invention relates to a view blind check system, and a view blind check method and a view blind method using the view blind check system.

### 2. DESCRIPTION OF THE RELATED ART

In recent years, design that offers a feeling of spatial openness to a working space such as a meeting room or a personal booth has been widely spread. For example, a large number of working spaces having a part or an entirety of a partition, which partitions a space, formed of a transparent member such as a glass plate or an acrylic plate to produce a feeling of openness have been designed and constructed. In many cases, a laptop personal computer (PC) or a tablet computer is brought into such working space by a user. The working space as described above offers a feeling of openness. Meanwhile, in some cases, there arises a problem in that information displayed on a display of the laptop PC or the like brought into the working space may be peeped by a third party.

Meanwhile, light output from the display of the laptop PC or the like is linearly polarized light in many cases. Thus, as a method of solving a peeping problem, for example, in U.S. Pat. No. 6,552,850, there has been proposed that a partition including a polarizing film arranged so that the polarization direction of light to be output and an absorption-axis direction become parallel to each other is arranged, to thereby make information displayed on the display invisible from an outside (hereinafter making information displayed on the display invisible is sometimes referred to as “blinding (the display)” or sometimes simply referred to as “blind”).

### SUMMARY OF THE INVENTION

However, in the case where the polarization direction of light to be output from the display of the laptop PC or the like brought into the working space is not known, even when the partition including the polarizing film is arranged, a user may feel anxious about whether or not the display is blinded. Thus, the user is required to go outside the working space so as to check whether or not the display is blinded.

The present invention has been made to solve the related-art problem described above, and has a primary object to provide a view blind check system that allows whether or not the display is blinded to be checked inside a space where the polarizing film for preventing peeping is arranged.

[1] According to one aspect of the present invention, there is provided a view blind check system that allows whether or not a display arranged inside a space viewable through a polarizer is blinded to be checked, the view blind check system including: a polarizing film including the polarizer; and a mirror member. The mirror member is arranged on a side of the polarizing film opposite to a side on which the display is arranged so that the mirror member reflects an image of the display through the polarizing film.

[2] In the view blind check system according to the above-mentioned item [1], the polarizing film may have a surface having a surface reflectance of 3% or less on the side on which the display is arranged.

[3] In the view blind check system according to the above-mentioned item [1] or [2], the polarizing film may further include an antireflection layer provided on the surface on the side on which the display is arranged.

[4] In the view blind check system according to any one of the above-mentioned items [1] to [3], the mirror member may be a wide-angle mirror member.

[5] In the view blind check system according to any one of the above-mentioned items [1] to [4], the polarizing film and the mirror member may be integrated.

[6] In the view blind check system according to any one of the above-mentioned items [1] to [4], the polarizing film and the mirror member may be arranged with a space therebetween.

[7] In the view blind check system according to any one of the above-mentioned items [1] to [4], the mirror member may be arranged diagonally with respect to the polarizing film.

[8] In the view blind check system according to any one of the above-mentioned items [1] to [7], the polarizing film may be arranged in a rotatable manner.

[9] In the view blind check system according to any one of the above-mentioned items [1] to [8], the mirror member may include a reflective layer and a protective base material arranged on a side of the polarizing film of the reflective layer, and the protective base material may have an Re(550) of 50 nm or less.

[10] According to another aspect of the present invention, there is provided a method of checking whether or not a display arranged inside a space viewable through a polarizer is blinded, the method including: arranging the display inside the space so that the mirror member reflects the image of the display through the polarizing film in the view blind check system of any one of the above-mentioned items [1] to [9]; and observing the image of the display through the polarizing film reflected by the mirror member.

[11] According to another aspect of the present invention, there is provided a method of blinding a display arranged inside a space viewable through a polarizer, the method including: arranging the display inside the space so that the mirror member reflects the image of the display through the polarizing film in the view blind check system of the above-mentioned item [8]; and observing the image of the display through the polarizing film reflected by the mirror member; wherein the polarizing film is rotated to blind the display when it is confirmed that the display is prevented from being blinded based on the observation.

With the view blind check system according to the embodiment of the present invention, the image of the display reflected by the mirror member can be observed from an inside of the space by arranging the mirror member outside the polarizing film, and thus whether or not the display is blinded can be checked.

### BRIEF DESCRIPTION OF THE DRAWINGS

FIG. 1A and FIG. 1B are each a schematic view for illustrating a view blind check system according to one embodiment of the present invention.

FIG. 2 is a schematic view for illustrating an example of a method of using the view blind check system according to one embodiment of the present invention.

FIG. 3 is a schematic view for illustrating reflection.

FIG. 4 is a schematic view for illustrating the view blind check system according to one embodiment of the present invention.

FIG. 5 is a schematic view for illustrating the view blind check system according to one embodiment of the present invention.

FIG. 6A and FIG. 6B are each a schematic sectional view for illustrating the configuration of an example of a polarizing film to be used in the present invention.

FIG. 7A and FIG. 7B are each a schematic view for illustrating the view blind check system according to one embodiment of the present invention.

### DESCRIPTION OF THE EMBODIMENTS

Typical embodiments of the present invention are described below. However, the present invention is not limited to these embodiments. The embodiments may be appropriately combined with each other except for the case that is clearly inappropriate. For better visualization, the accompanying drawings are schematic. Thus, a thickness and a size of each of constituent elements and a ratio of, for example, the thicknesses of the constituent elements in the drawings are different from actual values. In addition, as used herein, the term “parallel” encompasses the case of 0°±10°, and may be preferably 0°±5°, more preferably 0°±3°. The term “orthogonal” encompasses the case of 90°±10°, and may be preferably 90°±5°, more preferably 90°±3°.

### A. View Blind Check System

A view blind check system according to an embodiment of the present invention is a view blind check system that allows whether or not a display arranged inside a space viewable through a polarizer is blinded to be checked. The view blind check system includes a polarizing film including the polarizer, and a mirror member. The mirror member is arranged on a side of the polarizing film opposite to a side on which the display is arranged so that the mirror member reflects an image of the display through the polarizing film.

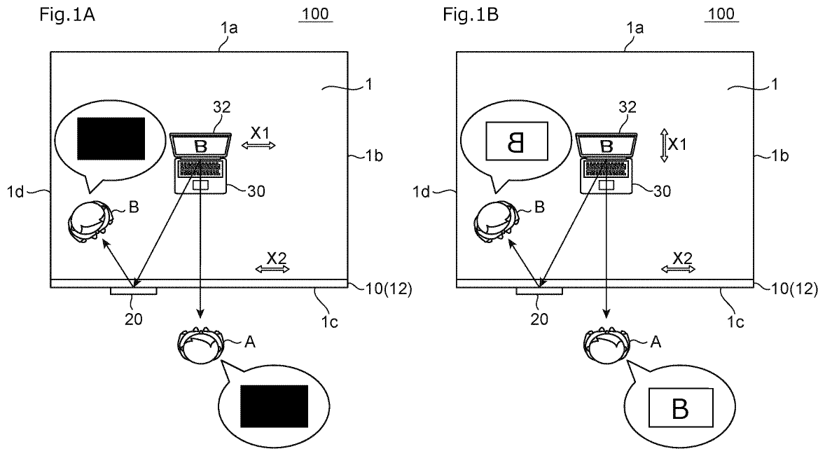

FIG. 1A and FIG. 1B are each a schematic view for illustrating a view blind check system 100 according to one embodiment of the present invention, which is a view of a space 1 viewable through a polarizer when seen from above. The space 1 is defined by walls 1a, 1b, 1c, and 1d. The wall 1c is formed of a transparent member. A polarizing film 10 including a polarizer 12 is arranged on an inner side of the wall 1c, and a mirror member 20 is arranged on an outer side thereof. The polarizing film 10 and the mirror member 20 are each bonded to the wall 1c via, for example, an adhesion layer (a pressure-sensitive adhesive layer, an adhesive layer, etc.). An image display apparatus 30 includes a display 32, and the image display apparatus 30 is arranged inside the space 1 so that the display 32 faces toward the polarizing film 10. The position at which the image display apparatus 30 is arranged is within a field of view of the mirror member 20 (within a range reflected by the mirror member 20). Thus, the mirror member 20 can reflect an image of the display 32 through the polarizing film 10. In FIG. 1A and FIG. 1B, the arrow X1 indicates the polarization direction of light output from the display 32, and the arrow X2 indicates the absorption-axis direction of the polarizer 12 included in the polarizing film 10. In addition, the sheet surface left-and-right direction is assumed to be a horizontal direction.

With the system 100, when the polarization direction X1 of the light (light representing an image) output from the display 32 and the absorption-axis direction X2 of the polarizer 12 included in the polarizing film 10 are parallel to each other (FIG. 1A), the light output from the display 32 is absorbed by the polarizing film 10. Thus, when a third party A positioned outside the space 1 observes the display 32 through the polarizing film 10, the display 32 is visually recognized as a black screen, and the display 32 is blinded (blindfolded). Meanwhile, inside the space 1, the light output from the display 32 is absorbed by the polarizing film 10, and hence is not reflected by the mirror member 20. Thus, the display 32 may be visually recognized as a black screen by a user B positioned inside the space 1. As a result, the user B can confirm from the inside of the space 1 that the display 32 is blinded.

Meanwhile, when the polarization direction X1 of the light (light representing an image) output from the display 32 and the absorption-axis direction X2 of the polarizer 12 included in the polarizing film 10 are orthogonal to each other (FIG. 1B), the light output from the display 32 passes through the polarizing film 10. Thus, the third party A positioned outside the space 1 can visually recognize a display image of the display 32 through the polarizing film 10. Meanwhile, inside the space 1, the light output from the display 32 is reflected by the mirror member 20 after passing through the polarizing film 10, and hence the light may be visually recognized as the display image by the user B positioned inside the space 1. The image (reflected image) of the display 32 through the polarizing film 10 reflected by the mirror member 20 is a left-and-right reversed image, and the left-and-right reversed display image may be visually recognized. Thus, the user B can confirm from the inside of the space 1 that the display 32 is not blinded.

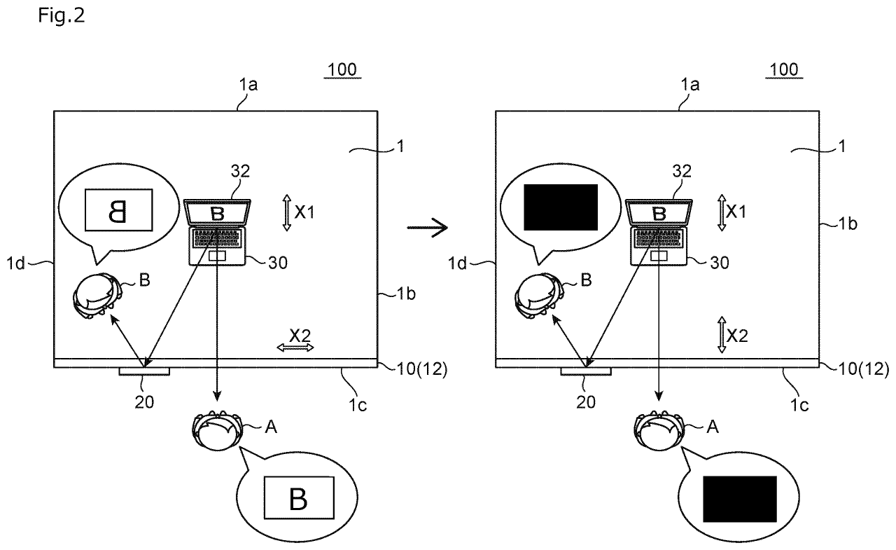

In one embodiment, the polarizing film 10 is arranged in a rotatable manner. With this configuration, as illustrated in FIG. 2, the user who has confirmed that the display 32 is not blinded can blind the display 32 by rotating the polarizing film 10 so that the polarization direction X1 of the light output from the display 32 and the absorption-axis direction X2 of the polarizer 12 included in the polarizing film 10 become parallel to each other. For example, when the polarizing film 10 is rotated in a clockwise direction or a counterclockwise direction by about 90°, the state in which the display 32 is not blinded (for example, the state in which the direction X1 and the direction X2 are orthogonal to each other) can be changed to the state in which the display 32 is blinded (for example, the state in which the direction X1 and the direction X2 are parallel to each other). The rotation mechanism is not limited and may be configured to allow the user to manually change the set angle or to allow the polarizing film 10 to be automatically rotated to an input set angle.

In the above-mentioned illustrated example, the polarizing film 10 and the mirror member 20 are laminated through intermediation of the wall 1c, but are not limited to the configuration in the illustrated example. For example, the polarizing film 10 and the mirror member 20 may be laminated in this order on an outer side of the space 1 of the wall 1c. In addition, the polarizing film 10 and the mirror member 20 are not required to be integrated. For example, the mirror member 20 may be arranged diagonally with respect to the polarizing film 10. In addition, for example, the polarizing film 10 and the mirror member 20 may be arranged with a space therebetween.

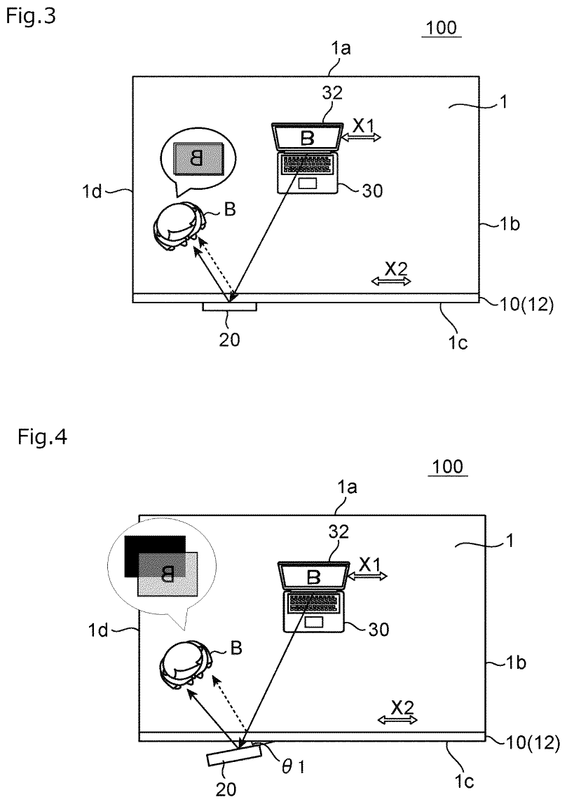

With the configuration in which the polarizing film 10 and the mirror member 20 are integrated by lamination as illustrated in FIG. 3, in a state in which the display 32 is blinded, there may be the case in which the image of the display 32 (left-and-right reversed display image) formed by the reflection from the polarizing film 10 is superimposed onto the image of the display 32 (black screen) through the polarizing film 10 formed by the reflection from the mirror member 20, with the result that it becomes difficult to clearly determine whether or not the display 32 is blinded.

Meanwhile, with the configuration in which the mirror member 20 is arranged diagonally with respect to the polarizing film 10 as illustrated in FIG. 4, the reflection angle from the polarizing film 10 and the reflection angle from the mirror member 20 can be made different. As a result, the image (black screen) formed by the reflection from the mirror member 20 and the image (left-and-right reversed display image) formed by the reflection from the polarizing film 10 can be identified in a separated state, and the above-mentioned problem of reflection can be suppressed. Thus, whether or not the display 32 is blinded can be easily determined.

In the above-mentioned configuration, an angle θ1 formed by the principal surface of the polarizing film 10 and the principal surface of the mirror member 20 is not limited as long as the effects of the present invention are obtained. The angle θ1 may be, for example, from 1° to 40° and may be, for example, from 10° to 30°.

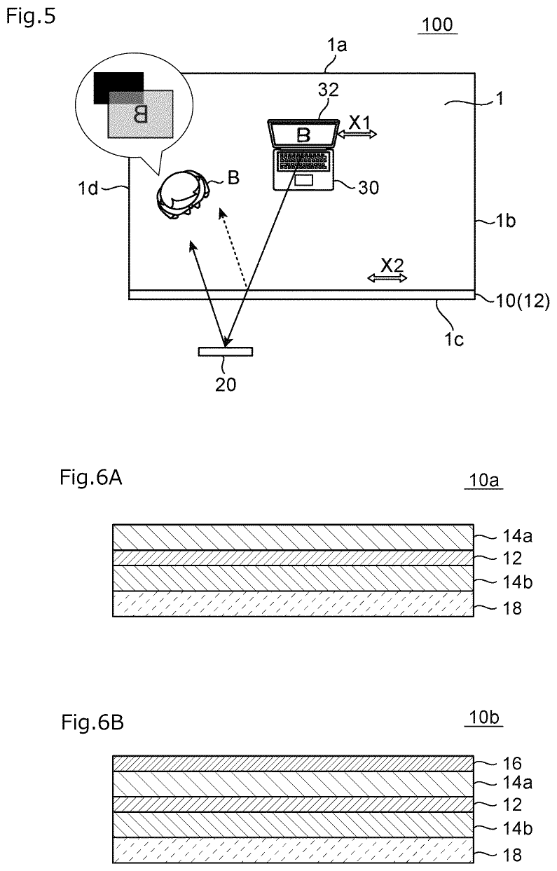

In addition, for example, with the configuration in which the polarizing film 10 and the mirror member 20 are arranged with a space therebetween as illustrated in FIG. 5, the reflected light from the polarizing film 10 and the reflected light from the mirror member 20 can be separated apart. As a result, the image (black screen) formed by the reflection from the mirror member 20 and the image (left-and-right reversed display image) formed by the reflection from the polarizing film 10 can be identified in a separated state, and the above-mentioned problem of reflection can be suppressed. Thus, whether or not the display 32 is blinded can be easily determined. As an example of the configuration illustrated in FIG. 5, there is given a configuration in which the polarizing film is installed on the surface of a wall defining a space, and the mirror member is installed on another wall provided apart from the above-mentioned wall over a passage.

In addition, for example, the reflection from the surface of the polarizing film can be suppressed through use of a polarizing film having a low surface reflectance. Thus, the above-mentioned problem of reflection is suppressed, and whether or not the display is blinded can be easily determined. The surface reflectance of the surface of the polarizing film on an inner side of the space is, for example, 3% or less, preferably 2.5% or less, more preferably 2% or less, still more preferably 1% or less, and may be, for example, 0.1% or more.

### <Polarizing Film>

FIG. 6A and FIG. 6B are each a schematic sectional view for illustrating the configuration of an example of the polarizing film. A polarizing film 10a includes a polarizer 12, an inner protective layer 14a arranged on one side of the polarizer 12, and an outer protective layer 14b arranged on another side thereof. Here, the terms “inner” and “outer” mean the inner side and the outer side of the space 1.

A polarizing film 10b includes the polarizer 12, the inner protective layer 14a arranged on one side of the polarizer 12, the outer protective layer 14b arranged on another side thereof, and an antireflection layer 16 arranged on a side of the inner protective layer 14a opposite to the side on which the polarizer 12 is arranged. The antireflection layer 16 may be an outermost layer on an inner side of the polarizing film 10b. When the antireflection layer is provided on the inner surface, a polarizing film having the inner surface in which the surface reflectance falls within the above-mentioned preferred ranges may be suitably obtained.

The inner protective layer and the outer protective layer are bonded to the polarizer, for example, via an adhesion layer (for example, an adhesive layer). Any one of the inner protective layer or the outer protective layer may be omitted in accordance with purposes.

The polarizing films 10a and 10b may each include a pressure-sensitive adhesive layer 18 as an outermost layer. With the configuration including the pressure-sensitive adhesive layer as the outermost layer, the pressure-sensitive adhesive layer enables the polarizing film to be suitably bonded to a transparent member defining a space such as a wall or a partition. Until the polarizing films 10a and 10b are used, a release liner may be temporarily bonded to the surface of the pressure-sensitive adhesive layer 18.

The thickness of the polarizing film except the pressure-sensitive adhesive layer may be, for example, from 10 μm to 300 μm, preferably from 30 μm to 200 μm, more preferably from 50 μm to 120 μm.

Any appropriate polarizer may be adopted as a polarizer. The polarizer is typically formed of a polyvinyl alcohol (PVA)-based resin film containing a dichroic substance (e.g., iodine). Examples of the PVA-based resin include polyvinyl alcohol, a partially formalized polyvinyl alcohol, an ethylene-vinyl alcohol copolymer, and an ethylene-vinyl acetate copolymer-based partially saponified product. For example, the resin film for forming the polarizer may be a single-layer resin film or may be a laminate of two or more layers.

Specific examples of the polarizer formed of a single-layer resin film include hydrophilic polymer films, such as a PVA-based film, a partially formalized PVA-based film, and an ethylene-vinyl acetate copolymer-based partially saponified film, which have been subjected to dyeing treatment with a dichroic substance, such as iodine or a dichroic dye, and stretching treatment, and a polyene-based alignment film, such as a dehydrated product of PVA or a dehydrochlorinated product of polyvinyl chloride. A polarizer obtained by subjecting a PVA-based film to dyeing with iodine and uniaxial stretching is preferably used because such polarizer is excellent in optical characteristics.

The dyeing with iodine is performed by, for example, immersing the PVA-based film in an aqueous solution of iodine. The stretching ratio of the uniaxial stretching is preferably from 3 times to 7 times. The stretching may be performed after the dyeing treatment, or may be performed while the dyeing is performed. In addition, the dyeing may be performed after the stretching. As required, the PVA-based film is subjected to swelling treatment, cross-linking treatment, washing treatment, drying treatment, and the like. For example, when the PVA-based film is washed with water by being immersed in water before the dyeing, not only contamination and an anti-blocking agent on the surface of the PVA-based film can be washed off, but also the PVA-based film can be swollen to prevent dyeing unevenness and the like.

A specific example of the polarizer obtained by using the laminate is a polarizer obtained by using a laminate of a resin substrate and a PVA-based resin layer (PVA-based resin film) laminated on the resin substrate or a laminate of a resin substrate and a PVA-based resin layer formed on the resin substrate through application. The polarizer obtained by using the laminate of the resin substrate and the PVA-based resin layer formed on the resin substrate through application may be produced, for example, by: applying a PVA-based resin solution to the resin substrate; drying the solution to form the PVA-based resin layer on the resin substrate, to thereby provide the laminate of the resin substrate and the PVA-based resin layer; and stretching and dyeing the laminate to turn the PVA-based resin layer into the polarizer. In this embodiment, a polyvinyl alcohol-based resin layer containing a halide and a polyvinyl alcohol-based resin is preferably formed on one side of the resin substrate. The stretching typically includes stretching the laminate under a state in which the laminate is immersed in an aqueous solution of boric acid. Further, the stretching may further include in-air stretching of the laminate at high temperature (e.g., 95° C. or more) before the stretching in the aqueous solution of boric acid as required. In addition, in this embodiment, the laminate is preferably subjected to drying shrinkage treatment, which includes heating the laminate, while conveying the laminate in a lengthwise direction thereof, to shrink the laminate by 2% or more in a widthwise direction thereof. The production method of this embodiment typically includes subjecting the laminate to in-air auxiliary stretching treatment, dyeing treatment, underwater stretching treatment, and drying shrinkage treatment in the stated order. When the auxiliary stretching is introduced, even in the case where PVA is applied onto a thermoplastic resin substrate, the crystallinity of PVA can be improved, and hence high optical characteristics can be achieved. In addition, when the alignment property of PVA is improved in advance simultaneously with the crystallinity improvement, problems, such as a reduction in alignment property of PVA and the dissolution thereof, can be prevented at the time of the immersion of the laminate in water in the subsequent dyeing step or stretching step, and hence high optical characteristics can be achieved. Further, in the case where the PVA-based resin layer is immersed in a liquid, the disturbance of the alignment of the molecules of polyvinyl alcohol and reductions in alignment properties thereof can be suppressed as compared to those in the case where the PVA-based resin layer is free of any halide. Thus, the optical characteristics of the polarizer to be obtained through treatment steps performed by immersing the laminate in a liquid, such as the dyeing treatment and the underwater stretching treatment, can be improved. Further, the optical characteristics can be improved by shrinking the laminate in its widthwise direction through the drying shrinkage treatment. The resultant laminate of the resin substrate and the polarizer may be used as it is (that is, the resin substrate may be used as a protective layer for the polarizer), or may be used by laminating any appropriate protective layer in accordance with purposes on the peeled surface on which the resin substrate has been peeled from the laminate of the resin substrate and the polarizer, or on a surface on an opposite side to the peeled surface. Details about such method of producing the polarizer are described in, for example, JP 2012-73580 A and JP 6470455 B1, the descriptions of which are incorporated herein by reference in their entirety.

The thickness of the polarizer is typically 20 μm or less, for example, 12 μm or less, preferably 10 μm or less, more preferably from 1 μm to 8 μm, still more preferably from 3 μm to 7 μm.

The polarizer preferably shows absorption dichroism at a certain wavelength in the wavelength range of from 380 nm to 780 nm. The single layer transmittance of the polarizer is preferably from 41.0% to 46.0%, more preferably from 42.0% to 45.0%. The polarization degree of the polarizer is preferably 97.0% or more, more preferably 99.0% or more, still more preferably 99.9% or more.

The protective layer is formed of any appropriate resin film. A material for forming the resin film is typically a cellulose-based resin such as triacetylcellulose (TAC), a cycloolefin-based resin such as polynorbornene, a (meth)acrylic resin, a polyester-based resin, such as polyethylene terephthalate (PET) or polyethylene naphthalate (PEN), a polyolefin-based resin such as polyethylene, or a polycarbonate-based resin. A typical example of the (meth)acrylic resin is a (meth)acrylic resin having a lactone ring structure. The (meth)acrylic resin having a lactone ring structure is described in, for example, JP 2000-230016 A, JP 2001-151814 A, JP 2002-120326 A, JP 2002-254544 A, and JP 2005-146084 A, which are incorporated herein by reference.

The thickness of the protective layer is preferably from 10 μm to 80 μm, more preferably from 12 μm to 40 μm, still more preferably from 15 μm to 35 μm.

The antireflection layer is a low-reflection layer to be provided for the purpose of preventing the reflection of ambient light from the surface of the polarizing film. Any appropriate configuration may be adopted as the antireflection layer. Examples thereof include a multi-coat type antireflection layer in which a plurality of thin films having different refractive indices are laminated to cause light to interfere with each other to reduce normal reflection and a moth-eye type antireflection layer having an uneven structure in which a large number of minute projections are regularly arranged at intervals equal to or less than the shortest wavelength in the wavelength range of light to be prevented from being reflected. The moth-eye type antireflection layer can prevent light reflection by continuously changing the refractive index with respect to incident light in a thickness direction to eliminate the discontinuous interface of the refractive index.

The antireflection layer may be formed on a support base material. In this case, an antireflection film having a laminated structure of the support base material and the antireflection layer can be bonded to the inner protective layer (or the polarizer when the inner protective layer is omitted) via an adhesion layer (typically, an adhesive layer or a pressure-sensitive adhesive layer). Various commercially available products are available as the antireflection film. Alternatively, the antireflection layer may be provided directly on the inner protective layer. The multi-coat type antireflection layer may be generally produced by a vapor deposition method.

The surface reflectance of the antireflection layer is, for example, 3% or less, preferably 2.5% or less, more preferably 2% or less, still more preferably 1% or less, and may be, for example, 0.1% or more.

### <Mirror Member>

The mirror member has a reflective surface on at least one side and reflects light transmitted through the polarizing film on the reflective surface. Thus, the user can visually recognize an image (reflected image) of the display through the polarizing film from an inside of the space.

The total light reflectance of the reflective surface of the mirror member is, for example, 80.0% or more, preferably 85.0% or more, more preferably 90.0% or more. The total light reflectance may be, for example, 99.0% or less and may be, for example, 98.0% or less. From the viewpoint of obtaining a clear reflected image, it is preferred that the reflection from the reflective surface be specular reflection. Thus, the total light reflectance of the reflective surface may be a specular reflectance.

Typical examples of the mirror member include a glass mirror and a resin mirror each including a reflective layer and a protective base material. When the surface on the protective base material side is used as the reflective surface, a protective coating layer may be provided on a side of the reflective layer opposite to the side on which the protective base material is arranged for the purpose of moisture proofing, rust proofing and the like.

The reflective layer is typically a metal layer, and is preferably a mirror-finished metal layer. A material for forming the metal layer is, for example, a metal, such as aluminum, silver, chromium, or tin, or alloys or oxides of these metals. Of those, aluminum or an alloy containing aluminum is preferred.

The metal layer may be a layer formed through a dry process, may be a layer formed by metal spraying, or may be a metal foil. Specific examples of the dry process include a physical vapor deposition (PVD) method and a chemical vapor deposition (CVD) method. Examples of the PVD method include a vacuum vapor deposition method, a reactive vapor deposition method, an ion beam assisted deposition method, a sputtering method, and an ion plating method. An example of the CVD method is a plasma CVD method.

A thickness of the metal layer formed through a dry process is preferably from 10 nm to 150 nm, more preferably from 20 nm to 100 nm. A thickness of the metal layer formed of a metal foil is preferably from 1 μm to 200 μm, more preferably from 10 μm to 100 μm.

A material for forming the protective base material is, for example, a transparent resin, such as a polycarbonate resin, an acrylic resin, a polystyrene resin, a polyethylene resin, or a polyethylene terephthalate resin, or glass.

In the case where the protective base material has an in-plane retardation (an Re(550) of, for example, more than 50 nm and for example, 100 nm or more), in a configuration in which the polarizing film and the mirror member are integrated, when the angle formed by the absorption-axis direction of the polarizing film and the slow-axis direction of the protective base material of the mirror member is from 10° to 80° in a clockwise direction or a counterclockwise direction based on the absorption-axis direction of the polarizing film, the reflected light may be colored due to the in-plane retardation of the protective base material.

Meanwhile, the reflected light can be prevented from being colored due to the in-plane retardation of the protective base material by integrating the polarizing film and the mirror member so that the absorption-axis direction of the polarizing film and the slow-axis direction of the protective base material are parallel or orthogonal to each other (for example, by bonding the polarizing film and the mirror member via an adhesive layer). In addition, in a configuration in which the polarizing film and the mirror member are installed with a space therebetween and only the polarizing film can be rotated, the angle formed by the absorption-axis direction of the polarizing film and the slow-axis direction of the protective base material of the mirror member is continuously changed due to the rotation of the polarizing film, and hence there may be the case in which a non-colored state and a colored state alternately appear, with the result that it becomes difficult to clearly determine whether or not the display is blinded.

Meanwhile, through use of a protective base material having an Re(550) of, for example, 50 nm or less and for example, from 0 nm to 30 nm, the reflected light can be prevented from being colored due to the in-plane retardation of the protective base material when the polarizing film is rotated. In addition, when the in-plane retardation of the protective base material falls within the above-mentioned ranges, the above-mentioned problem of coloring when the angle formed by the absorption-axis direction of the polarizing film and the slow-axis direction of the protective base material of the mirror member is from 10° to 80° in a clockwise direction or a counterclockwise direction based on the absorption-axis direction of the polarizing film can also be prevented.

The above-mentioned Re(550) is an in-plane retardation measured with light having a wavelength of 550 nm at 23° C. and is determined by the formula: Re(550)=(nx−ny)×d, where the “d (nm)” represents the thickness of the base material. The “nx” represents a refractive index in a direction in which the in-plane refractive index becomes maximum (i.e., in the slow-axis direction), and the “ny” represents a refractive index in a direction orthogonal to the slow axis in a plane (i.e., in a fast-axis direction).

The mirror member may be a stainless mirror without a protective base material. In the stainless mirror, a mirror surface (reflective surface) is formed by polishing the surface of stainless steel, and hence the coloring of the reflected light due to the in-plane retardation of the protective base material when the polarizing film is rotated can be avoided.

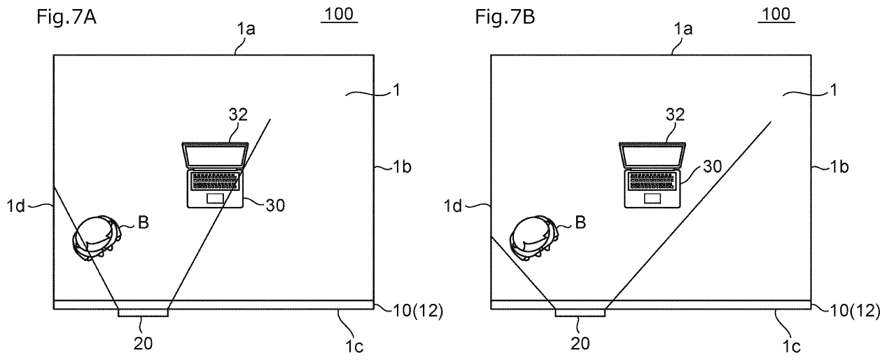

In one embodiment, the mirror member is a wide-angle mirror member. The wide-angle mirror member can reflect a wider range as compared to an ordinary mirror member (planar mirror) in which a reflective layer is planar. Thus, as illustrated in FIG. 7A and FIG. 7B, the range in which the display to be checked regarding whether or not the display is blinded can be arranged and the range in which the image reflected by the mirror member can be checked can be widened (an embodiment using the ordinary mirror member is illustrated in FIG. 7A, and an embodiment using the wide-angle mirror member is illustrated in FIG. 7B).

Any appropriate configuration may be adopted as the wide-angle mirror member. Preferred examples of the wide-angle mirror member include a convex surface mirror in which a reflective layer has a convex surface, a hemispherical mirror, and a Fresnel mirror. The Fresnel mirror may have a configuration, for example, using a protective base material having a large number of annular grooves having a V-shaped cross section with sequentially different diameters and inclination angles formed so as to be arrayed in a concentric manner on a back surface, in which a reflective layer is laminated on the annular grooves on the back surface. Any appropriate shape may be used as the shape of the mirror member. The shape of the mirror member is not limited to a quadrangular shape, but may be any appropriate shape such as a circular shape or an elliptical shape.

### B. Method of Using View Blind Check System

The view blind check system described in the section A may be used for checking whether or not a display arranged inside a space viewable through a polarizer is blinded. Thus, according to another aspect of the present invention, there is provided a method of checking whether or not a display arranged inside a space viewable through a polarizer is blinded, including, in the view blind check system described in the section A, arranging the display inside the space so that the mirror member reflects an image of the display through the polarizing film and observing the image of the display through the polarizing film reflected by the mirror member. In this method, when the image of the display reflected by the mirror member is observed as a black screen inside the space, it can be confirmed from the inside of the space that the display is blinded. When the display image is observed in the image of the display reflected by the mirror member inside the space, it can be confirmed from the inside of the space that the display is not blinded.

In the above-mentioned method, with the view blind check system in which the polarizing film is arranged in a rotatable manner, when it is confirmed that the display is not blinded based on the above-mentioned observation, the display can be blinded by rotating the polarizing film.

### EXAMPLES

The present invention is specifically described below by way of Examples. However, the present invention is not limited to these Examples.

### <Thickness>

A thickness of 10 μm or less was measured with a scanning electron microscope (product name “JSM-7100F”, manufactured by JEOL Ltd.). The thickness of more than 10 μm was measured with a digital micrometer (product name “KC-351C”, manufactured by Anritsu Corporation).

### <Single Layer Transmittance and Polarization Degree>

A single layer transmittance Ts, a parallel transmittance Tp, and a cross transmittance Tc of a laminate having a configuration of [thermoplastic resin base material/polarizer]were measured with a spectrophotometer (“LPF-200”, manufactured by Otsuka Electronics Co., Ltd.). These Ts, Tp, and Tc are Y values measured by the 2-degree field of view (C light source) of JIS Z8701 and subjected to visibility correction. From the resultant Tp and Tc, the polarization degree was determined through use of the following formula.

$$Polarization Degree ( \% ) = {\{ ( Tp - Tc ) / ( Tp + Tc ) \}}^{1 / 2} \times 100$$

### <Surface Reflectance>

An antireflection film was bonded to a black acrylic plate so that an antireflection layer was an exposed surface to provide a measurement sample. The measurement sample was measured for total light reflectance with a spectrophotometer (“UH-4150”, manufactured by Hitachi High-Technologies Corporation). The total light reflectance was determined as a ratio of the amount of light reflected by the measurement sample to the amount of light reflected by a reference sample (relative reflectance) through use of a standard white plate of barium sulfate as the reference sample. The total light reflectance was obtained as described below. Measurement was performed in a wavelength range of from 380 nm to 780 nm at intervals of 5 nm, and the resultant measurement values were multiplied by a weight value coefficient obtained from the spectrum of the C light source and the wavelength distribution of the visibility of the 2-degree field of view, followed by averaging, to provide a total light reflectance (Y value).

### Production Example 1: Polarizing Film A

An amorphous isophthalic acid-copolymerized polyethylene terephthalate film (thickness: 100 μm) having an elongate shape, and a Tg of about 75° C. was used as a thermoplastic resin substrate, and one surface of the resin substrate was subjected to corona treatment.

A product obtained by adding 13 parts by weight of potassium iodide to 100 parts by weight of a PVA-based resin, which had been obtained by mixing polyvinyl alcohol (polymerization degree: 4,200, saponification degree: 99.2 mol %) and acetoacetyl-modified PVA (manufactured by the Nippon Synthetic Chemical Industry Co., Ltd., product name: “Gohsefimer”) at 9:1, was dissolved in water to prepare a PVA aqueous solution (application liquid).

The PVA aqueous solution was applied to the corona-treated surface of the resin substrate, and was dried at 60° C. to form a PVA-based resin layer having a thickness of 13 μm. Thus, a laminate was produced.

The resultant laminate was subjected to uniaxial stretching in its longitudinal direction (lengthwise direction) at a ratio of 2.4 times in an oven at 130° C. (in-air auxiliary stretching treatment).

Next, the laminate was immersed in an insolubilizing bath having a liquid temperature of 40° C. (aqueous solution of boric acid obtained by blending 100 parts by weight of water with 4 parts by weight of boric acid) for 30 seconds (insolubilizing treatment).

Next, the laminate was immersed in a dyeing bath having a liquid temperature of 30° C. (aqueous solution of iodine obtained by blending 100 parts by weight of water with iodine and potassium iodide at a weight ratio of 1:7) for 60 seconds while the concentration of the aqueous solution was adjusted so that the single layer transmittance (Ts) of a polarizer to be finally obtained became a desired value (dyeing treatment).

Next, the laminate was immersed in a cross-linking bath having a liquid temperature of 40° C. (aqueous solution of boric acid obtained by blending 100 parts by weight of water with 3 parts by weight of potassium iodide and 5 parts by weight of boric acid) for 30 seconds (cross-linking treatment).

After that, while the laminate was immersed in an aqueous solution of boric acid having a liquid temperature of 70° C. (boric acid concentration: 4 wt %, potassium iodide concentration: 5 wt %), the laminate was subjected to uniaxial stretching in the longitudinal direction (lengthwise direction) between rolls having different peripheral speeds so that the total stretching ratio became 5.5 times (underwater stretching treatment).

After that, the laminate was immersed in a washing bath having a liquid temperature of 20° C. (aqueous solution obtained by blending 100 parts by weight of water with 4 parts by weight of potassium iodide) (washing treatment).

After that, the laminate was brought into contact with a SUS-made heating roll whose surface temperature was kept at about 75° C. while being dried in an oven kept at about 90° C. (drying shrinkage treatment).

Thus, a polarizer having a thickness of about 5 μm was formed on the thermoplastic resin substrate to thereby form a laminate having the configuration of [thermoplastic resin substrate/polarizer]. A single layer transmittance Ts of the polarizer was 43% and a degree of polarization was 99.9%.

A triacetylcellulose (TAC) film (with a thickness of 25 μm) was bonded to a surface (opposite to the resin substrate) of the resultant polarizer via an adhesive layer. Subsequently, the resin substrate was peeled from the polarizer, then, a TAC film, which was the same as the TAC film described above, was bonded to the peeled surface via an adhesive layer, and an acrylic pressure-sensitive adhesive layer was laminated thereon together with a release liner. Thus, a polarizing film A having the configuration of [TAC film (inner protective layer)/polarizer/TAC film (outer protective layer)/pressure-sensitive adhesive layer]was obtained.

### Production Example 2: Polarizing Film B

A polarizing film B having a configuration of [antireflection layer/TAC film (inner protective layer)/polarizer/TAC film (outer protective layer)/pressure-sensitive adhesive layer] was obtained in the same manner as in Production Example 1 except that an antireflection film (manufactured by Toppan Tomoegawa Optical Films Co., Ltd.) having a laminated structure of a support base material and an antireflection layer was bonded to the surface of the inner protective layer via an acrylic pressure-sensitive adhesive layer. The surface reflectance of the antireflection film on the antireflection layer side was 0.9%.

### Example 1

A commercially available laptop PC (“Elite Dragonfly G2”, manufactured by Hewlett-Packard Company) was arranged in a room which was defined by four walls and in which a window made of a glass plate measuring 2,500 mm (height) by 3,000 mm (width) was provided to the wall facing a hallway side. A display of the laptop PC outputs linearly polarized light.

The surface of the pressure-sensitive adhesive layer of the polarizing film A was bonded to the entire surface of the window on an inner side (in other words, the surface on a side on which the laptop PC was arranged). In this case, the bonding was performed so that the absorption-axis direction of the polarizer of the polarizing film A was parallel to the polarization direction of the linearly polarized light output from the display.

Then, a mirror A measuring 300 mm (height) by 200 mm (width) was bonded to the surface of the window on an outer side via the pressure-sensitive adhesive layer so that a reflective surface was placed on a window side. In this case, the bonding was performed so that the mirror A reflected an image of the display of the laptop PC through the polarizing film A. As the mirror A, a glass mirror having a planar Al vapor-deposited layer as a reflective layer was used.

A view blind check system was configured in the manner as described above.

In the view blind check system, the laptop PC was turned on to display an image on the display.

When the display was observed through the window from the hallway side, a black screen was observed. From this, it was confirmed that the display image of the display was not able to be observed from an outside of the window, and the display was blinded by the polarizing film A.

Next, when the image of the display reflected by the mirror A was observed from an inside of the room, the color tone of the entire display was observed to be significantly dark. From this, it was able to be confirmed inside the room that the display was blinded by the polarizing film A. Meanwhile, the display image was visually recognized faintly in the image of the display observed inside the room, and it is understood that reflection of the reflected light on the surface of the polarizing film A (more specifically, the surface of the polarizing film A on the inner protective layer side) occurred. Such reflection was not desired in checking of the view blind situation.

### Example 2

The view blind check system was configured in the same manner as in Example 1 except that the polarizing film B was used instead of the polarizing film A.

In the view blind check system, the laptop PC was turned on to display an image on the display.

When the display was observed through the window from the hallway side, a black screen was observed. From this, it was confirmed that the display image of the display was not able to be observed from an outside of the window, and the display was blinded by the polarizing film B.

Next, when the image of the display reflected by the mirror A was observed from an inside of the room, no reflection occurred, and a black screen was observed. From this, it was easily able to be confirmed inside the room that the display was blinded by the polarizing film B.

### Example 3

The view blind check system was configured in the same manner as in Example 1 except that the Fresnel mirror B (“FF mirror”, manufactured by KOMY CO., LTD.) was used instead of the mirror A.

In the view blind check system, the laptop PC was turned on to display an image on the display.

When the display was observed through the window from the hallway side, a black screen was observed. From this, it was confirmed that the display image of the display was not able to be observed from an outside of the window, and the display was blinded by the polarizing film A.

Next, when the image of the display reflected by the Fresnel mirror B was observed from an inside of the room, the color tone of the entire display was observed to be significantly dark. From this, it was able to be confirmed inside the room that the display was blinded by the polarizing film A. Meanwhile, the display image was visually recognized faintly in the image of the display observed inside the room, and it is understood that reflection of the reflected light on the surface of the polarizing film A occurred. Such reflection was not desired in checking of the view blind situation.

Meanwhile, the Fresnel mirror B was able to reflect a wider range as compared to the mirror A, and hence the degree of freedom in arrangement position of the laptop PC at the time of checking the view blind situation was higher than that in Example 1.

### Example 4

The view blind check system was configured in the same manner as in Example 2 except that the Fresnel mirror B (“FF mirror”, manufactured by KOMY CO., LTD.) was used instead of the mirror A.

In the view blind check system, the laptop PC was turned on to display an image on the display.

When the display was observed through the window from the hallway side, a black screen was observed. From this, it was confirmed that the display image of the display was not able to be observed from an outside of the window, and the display was blinded by the polarizing film B.

Next, when the image of the display reflected by the Fresnel mirror B was observed from an inside of the room, no reflection occurred, and a black screen was observed. From this, it was easily able to be confirmed inside the room that the display was blinded by the polarizing film B.

In addition, the Fresnel mirror B was able to reflect a wider range as compared to the mirror A, and hence the degree of freedom in arrangement position of the laptop PC at the time of checking the view blind situation was higher than that in Example 2.

### Comparative Example 1

A view blind check system was configured in the same manner as in Example 1 except that the mirror A was not used.

In the view blind check system, the laptop PC was turned on to display an image on the display.

When the display was observed through the window from the hallway side, a black screen was observed. From this, it was confirmed that the display image of the display was not able to be observed from an outside of the window, and the display was blinded by the polarizing film A.

Next, when the polarizing film A was observed from an inside of the room, the image of the display by the reflection from the surface of the polarizing film A was visually recognized, and only a left-and-right reversed display image was visually recognized in this image. Thus, it was not able to be checked inside the room whether or not the display was blinded by the polarizing film A.

The configuration of the view blind check system and the blind check results of each of the above-mentioned Examples and Comparative Examples are summarized in Table 1.

TABLE 1

| | Comparative | Example | Example | Example | Example |
|---|---|---|---|---|---|
| | Example 1 | 1 | 2 | 3 | 4 |
| | Inner side of space (laptop PC side) | | | | |
| | | | Anti- | | Anti- |
| | | | reflection | | reflection |
| | | | layer | | layer |
| | Polarizer | Polarizer | Polarizer | Polarizer | Polarizer |
| | | Mirror | Mirror | Fresnel | Fresnel |
| Con- | | A | A | mirror B | mirror B |
| figuration | Outer side of space | | | | |
| View blind | Possible | Possible | Possible | Possible | Possible |
| check from | | | | | |
| outside of | | | | | |
| space | | | | | |
| View blind | Impossible | Possible | Possible | Possible | Possible |
| check from | | (Presence | (Absence | (Presence | (Absence |
| inside of | | of | of | of | of |
| space | | reflection) | reflection) | reflection) | reflection) |
| Area in | — | Ref | Δ | ○ | ○ |
| which PC | | | | | |
| can be | | | | | |
| installed | | | | | |

In table, ″Δ″ is the same as Ref, and ″○″ is wider than Ref.

It is understood that, with the view blind check system according to each of the Examples of the present invention, whether or not a display is blinded can be checked inside a space to which a polarizing film is applied.

The view blind check system according to each of the embodiments of the present invention may be suitably used in a working space or the like which requires information management.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A view blind check system that allows whether or not a display arranged inside a space viewable through a polarizer is blinded to be checked, the view blind check system comprising:
a polarizing film including the polarizer; and
a mirror member,
wherein the mirror member is arranged on a side of the polarizing film opposite to a side on which the display is arranged so that the mirror member reflects an image of the display through the polarizing film.

2. The view blind check system according to claim 1, wherein the polarizing film has a surface having a surface reflectance of 3% or less on the side on which the display is arranged.

3. The view blind check system according to claim 1, wherein the polarizing film further includes an antireflection layer provided on the surface on the side on which the display is arranged.

4. The view blind check system according to claim 1, wherein the mirror member is a wide-angle mirror member.

5. The view blind check system according to claim 1, wherein the polarizing film and the mirror member are integrated.

6. The view blind check system according to claim 1, wherein the polarizing film and the mirror member are arranged with a space therebetween.

7. The view blind check system according to claim 1, wherein the mirror member is arranged diagonally with respect to the polarizing film.

8. The view blind check system according to claim 1, wherein the polarizing film is arranged in a rotatable manner.

9. The view blind check system according to claim 1, wherein the mirror member includes a reflective layer and a protective base material arranged on a side of the polarizing film of the reflective layer,
wherein the protective base material has an Re(550) of 50 nm or less.

10. A method of checking whether or not a display arranged inside a space viewable through a polarizer is blinded,
the method comprising:
arranging the display inside the space so that the mirror member reflects the image of the display through the polarizing film in the view blind check system of claim 1; and
observing the image of the display through the polarizing film reflected by the mirror member.

11. A method of blinding a display arranged inside a space viewable through a polarizer,
the method comprising:
arranging the display inside the space so that the mirror member reflects the image of the display through the polarizing film in the view blind check system of claim 8; and
observing the image of the display through the polarizing film reflected by the mirror member;
wherein the polarizing film is rotated to blind the display when it is confirmed that the display is prevented from being blinded based on the observation.
